(19) United States
(12) Patent Application Publication
(10) Pub. No.: US 2026/0241468 A1
(43) Pub. Date: Aug. 20, 2026

(54) CUTTING INSERT FOR CUTTING TOOL AS WELL AS CUTTING TOOL AND METHODS FOR PRODUCING CUTTING INSERTS

(71) Applicant: Kennametal Inc., Latrobe, PA (US)

(72) Inventors: Fabian BIRKMANN, Schwaig (DE); Igor KAUFMANN, Nuremberg (DE)

(21) Appl. No.: 19/539,991

(22) Filed: Feb. 13, 2026

(30) Foreign Application Priority Data
Feb. 14, 2025 (DE) 1020251056749

(51) Int. Cl. B23C 5/22; B23B 27/04; B23B 27/14; B23B 27/16

(52) U.S. Cl. CPC B23C 5/2213; B23B 27/045; B23B 27/141; B23B 27/143; B23B 27/16; B23B 27/1611; B23B 27/164

(57) ABSTRACT

A cutting insert is shown for a cutting tool having an underside, an oppositely directed top side having a chip face, a free surface adjacent the chip face, and a cutting edge defined at the transition between the chip face and the free surface. The chip face extends away from the cutting edge and obliquely towards the underside and has a plurality of surface structures. The surface structures are arranged in multiple rows longitudinally to and spaced apart from the cutting edge. Here, the surface structures end in a ledge from the row closer to the cutting edge and the adjacent row begins further away from the cutting edge after the ledge. Analogously to the chip face, the top side of the surface structures extend away from the cutting edge and obliquely towards the underside. In addition, the ledges are convex in plan view of the top side.

Furthermore, a cutting tool and a method for producing a cutting insert are shown.

The invention relates to a cutting insert for a cutting tool having an underside, an oppositely directed top side having a chip face, a free surface adjacent the chip face, and a cutting edge defined at the transition between the chip face and the free surface. Furthermore, the invention relates to a cutting tool having such a cutting insert, as well as to a method for producing such a cutting insert.

Cutting inserts for cutting tools are known. In particular, cutting inserts are used in order to only replace the cutting insert and not the entire cutting tool due to the wear. Even with cutting inserts, there is a lot of wear due to the friction created during the cutting operation. Thus, for example, the cutting inserts become eroded, the coating of the cutting inserts peel off as well as indentations develop within the cutting surface and cutting edge becomes worn.

It is therefore an object of the invention to reduce the wear caused by the friction during the cutting operation while keeping the cost of the cutting insert to a minimum.

According to the present invention, this object is achieved by a cutting insert of the aforementioned type, wherein the cutting surface extends away from the cutting edge and obliquely towards the underside and has a plurality of surface structures. The surface structures are arranged in multiple rows longitudinally to and spaced apart from the cutting edge. In so doing, the surface structures from the row closer to the cutting edge end in a ledge and the adjacent row further away from the cutting edge begins after the ledge. The top side of the surface structures extend away from the cutting edge and are oblique towards the underside. In addition, the ledges are convex in plan view of the top side.

The invention is based on the basic idea that providing the surface structures reduces the contact surface area between the cutting insert and the object to be intersected and its chip so that wear resulting from the cutting operation can be reduced due to less friction. In particular, by providing the surface structures, ventilation is created such that the material of the cutting insert is heated more slowly and thus wear is reduced.

Preferably, the surface structures are macrostructures having a surface measuring from 0.02 to 2 mm² in plan view.

Alternatively, it is also contemplated that the surface structures are microstructures having a maximum surface area of 0.01mm².

In one aspect, each surface structure has a length measured parallel to the closest area of the cutting edge between 0.06 and 0.2 mm, preferably between 0.1 to 0.15 mm. A width of the surface structure measured perpendicular to the closest area of the cutting edge is between 0.04 and a maximum of 0.2 mm, preferably between 0.05 to 0.15 mm. Due to the convex course of the ledges in plan view as well as the requirement that the maximum length is greater than the maximum width, the surface structures can be semi-circular, for example.

The ledges facing away from the cutting edge may have an end face having an inclination greater than 90° and a maximum of 120° toward the top side of the respective surface structure from which it is extending. In other words, the surface structures, in particular the ledges, do not have sharp edges or otherwise abrupt directional changes, simplifying the production of the surface structures and thus the cutting insert. Further, an undercut on the ledge is thus ruled out, thereby simplifying production, e.g., by a pressing step of a sintered part.

In one aspect, the cutting edge has non-linear portions when viewed in plan view. Additionally, the top of all surface structures relative to a base plane in which the cutting edge lies is inclined at an angle of between 5 and 20°, preferably between 15 and 20°. The surface structures thereby define the desired inclination of the chip face, which must be inclined with respect to the base plane.

The adjacent surface structures of at least the row closest to the cutting edge may merge with each other, with each surface structure bound and defined in its longitudinal direction parallel to the closest region of the cutting edge by a singular convex ledge. Accordingly, the surface structures are formed from a plurality of individual structures, each of which forms a type of scale or brick.

In one aspect, the adjacent surface structures end at least the row closest to the cutting edge when viewed in plan view at a recess defined by the common end of the adjacent convex ledges. Accordingly, the individual surface structures merge into one another, wherein at the transition the adjacent ledges together border a recess.

In another aspect, the surface structures of the adjoining row which is further away from the cutting edge than the adjacent row, are offset from the adjacent row surface structures in the longitudinal direction that is parallel to the closest area of the cutting edge. The staggered arrangement of the individual rows of the surface structures results in a type of fish-scale pattern. The individual rows are preferably offset by 30 to 50% from each other. This means that the furthest point from the cutting edge of a row is disposed within the recess of the adjacent row, wherein the recess is defined by the adjacent ledges viewed in plan view.

Preferably, the top side of the surface structures of the adjoining row, which is further away from the cutting edge than the adjacent row when viewed in plan view, has its greatest width measured at the imaginary straight line perpendicular to the closest region of the cutting edge, next to which a recess of the adjoining row closer to the cutting edge is provided. This ensures a uniformity of the surface structures.

In one aspect, the surface of the top side of the surface structures become increasingly larger from the rows series closer to the cutting edge, such that the surface of the top side of the surface structures decreases with increasing distance from the cutting edge. In particular, the size of the top side of the surface structures decreases by a factor of 2 to 4.

The surface structures of the row that is not closest to the cutting edge in the longitudinal direction and that is parallel to the closest area of the cutting edge may be spaced apart from one another. In other words, these rows of surface structures do not have recesses created by adjacent surface structures.

Preferably, the ledges of the surface structures of all the rows have the same curvature, which facilitates production.

According to one aspect, the top side of the cutting insert comprises a chip-breaking trough starting from the cutting edge, wherein the surface structures are only present on the side of the trough close to the cutting edge.

Thus, the surface structures preferably end at the lowest point of the chip-breaking trough. Alternatively, however, the surface structures may also end at a distance to the lowest point of the chip-breaking trough.

In one aspect, starting from the cutting edge, a strip-shaped transition portion running parallel to the cutting edge is provided, which is free from the surface structures and at which edge located away from the cutting edge begins a first row of the surface structures. The width of the strip-shaped transition portion is preferably smaller than the width of the surface structures of the first row, whereby the width is at least 0.1 mm. Due to the distance between the cutting edge and the surface structures determined by the transition portion, the cutting edge is designed homogeneously and the stability of the cutting insert is increased.

The surface structures extend like overlying bricks on a level substructure in side view. The transition portion forms a level part of the chip face and thus a reference plane corresponding to the aforementioned substructure. The top side of the surface structures run at an angle of 1°-8° to this plane so that the top side of the ledges are increasingly spaced apart from the plane.

Preferably, the top sides of each surface structure are level. However, alternatively, the surface structures may each have a curved back, i.e., a curved surface, wherein the maximum height of curvature is between 0.02 and 0.2 mm.

According to a preferred aspect, the top side is free of undercuts. This means that the surface is made perpendicular to a plane in which the cutting edge lies, when viewed without a lateral undercut, so that all surfaces, except for those perpendicular to the plane, are visible from above.

In one aspect, the cutting insert is a cutting plate having cutting edge portions that are substantially linear and merge into corners of the cutting plate. This may be, for example, an insert whereby both the top side and underside have a chip face. Accordingly, there are several options for inserting the cutting insert into a cutting tool so that the use of the cutting insert can be prolonged as both sides of the cutting insert can be used.

Additionally, the cutting insert may contain friction-reducing particles that have lubricating properties or may become softer through heat from the cutting chips to form a lubrication layer. These particles also reduce friction between the cutting insert and the workpiece to be cut so that the cutting insert can be used for a long time. For example, the friction-reducing particles may be carbon (C), sulfur (S), or oil deposits in cavities provided for this purpose.

According to the present invention, the object is also solved by a cutting tool comprising a holder and a cutting insert described above. The cutting insert is attached to one end of the holder. In that the cutting insert of the cutting tool is interchangeable, costs can be saved, particularly because the cutting insert has an increased service life due to its surface structures.

The object is also solved according to the present invention by a method for producing a cutting insert according to the present invention. The method comprises the following steps:
producing a sintered preform,
compressing the sintered preform between at least two tool parts, the at least two tool parts being shaped complementary to the top side and the underside, and
heating and sintering the sintered preform.

The sintered preform can be compressed in one direction in particular by two tool parts.

Further features and advantages of the invention will be apparent from the following description as well as the attached drawing. The drawings show:

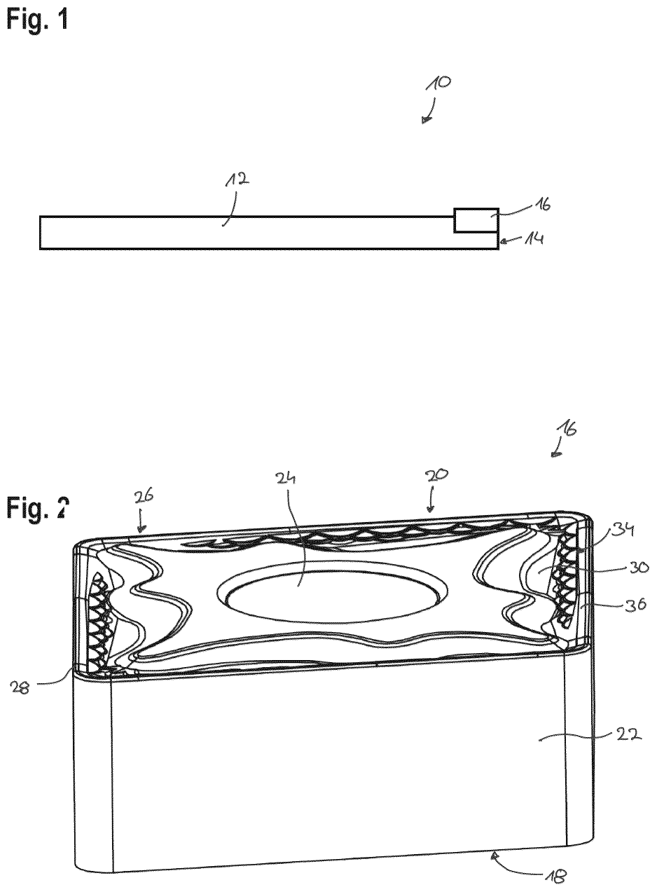

FIG. 1 a side view of a cutting tool according to the invention;

FIG. 2 a perspective view of a cutting insert according to the invention as used in FIG. 1;

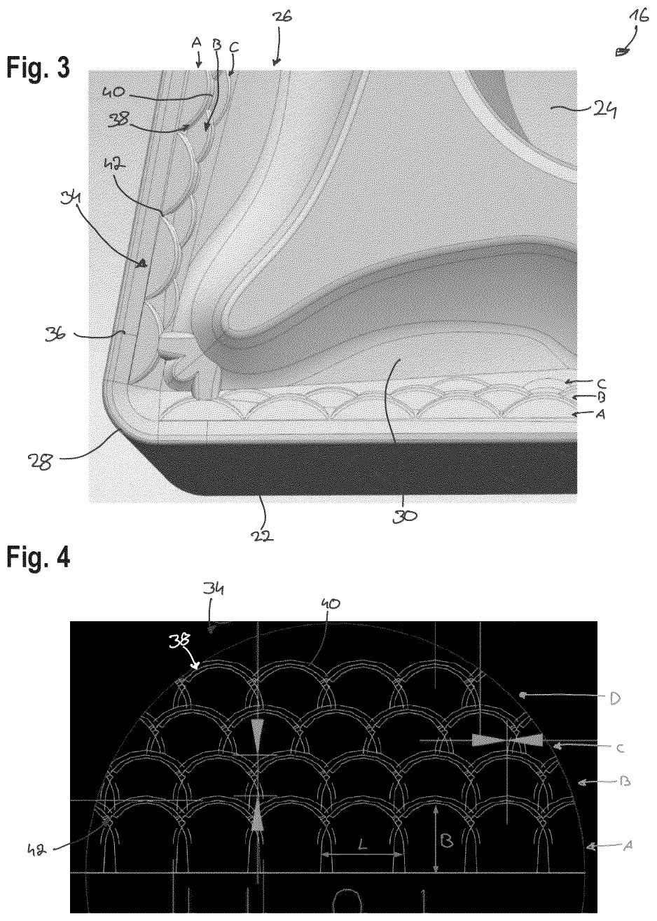

FIG. 3 an enlarged plan view of the cutting insert according to FIG. 2 in the area of the cutting edge;

FIG. 4 a detail view of a somewhat different surface structure of a cutting insert configured as in FIG. 2 except for the surface structure;

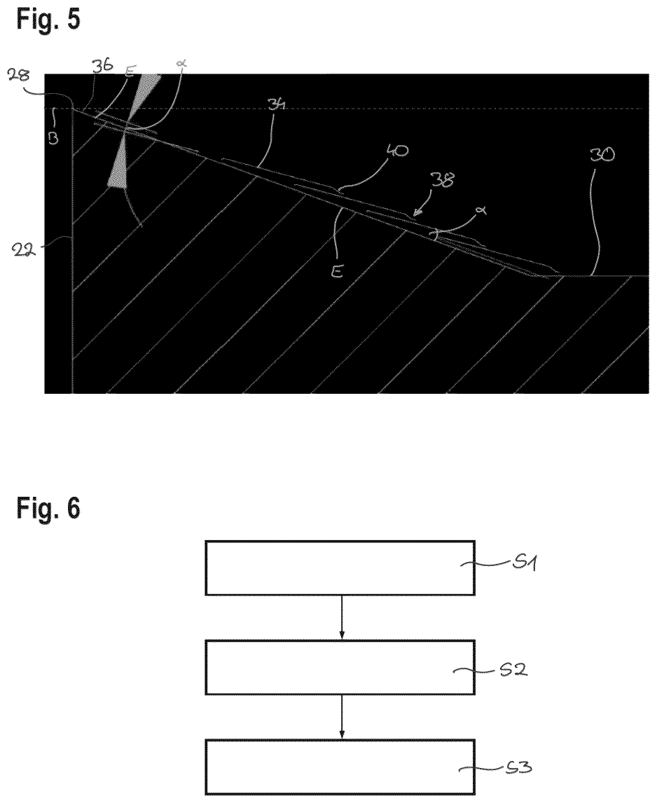

FIG. 5 a sectional view of the cutting insert shown in FIG. 2; and

FIG. 6 a flow chart of a method according to the invention for producing the cutting insert shown in FIG. 2.

In FIG. 1, a cutting tool 10 can be seen.

The cutting tool 10 comprises a holder 12, to which end 14 a cutting insert 16 is detachably fastened.

The cutting tool 10 shown is, in particular, a cutting tool 10 for machining manufacturing methods. However, the cutting tool 10 may also be understood as a cutting tool for splitting manufacturing methods.

The cutting insert 16 of the cutting tool 10 is shown in detail in FIGS. 2 to 5 and will be described below.

The cutting insert 16 is in particular a rotatable cutting plate having cutting edge portions. These cutting edge portions run substantially linearly along the associated longitudinal side of the cuboid cutting insert 34 and merge into each other in the rounded corners of the cutting insert 16. While the embodiment shown in the figures indicates only a chip face 26 is provided on the top side 20, the cutting insert 16 may also be an indexable insert whereby a chip face 26 is provided on both the top side 20 and the underside 18. Accordingly, the cutting insert 16 may be used longer (i.e., longer service life) and more flexibly.

As can be seen in FIG. 2 in particular, the cutting insert 16 has an underside 18, an oppositely directed top side 20, and a free surface 22 in between. A hole 24 is provided in the center of the cutting insert 16, which is used to fasten the cutting insert 16 to the cutting tool 10.

The top side 20 has a chip face 26 that abuts the circumferential free surface 22. A cutting edge 28 is defined at the transition between the chip face 26 and the free surface 22.

As can be seen in FIGS. 2 and 5 in particular, the chip face 26 extends obliquely from the cutting edge 28 towards the lower surface 18, such that a trough-like recess is created on the upper surface 20 by the cutting surface 26, which forms a chip-guiding trough 30. In so doing, chip-breaking contours are provided at the cutting edge 28 on far side of the chip-breaking trough 30, which are intended to prevent long chips from forming.

In contrast, surface structures 34 are provided on the side of the cutting edge 28 near the chip-breaking trough 30. The plurality of surface structures 34 disposed on the chip face 26 are arranged in multiple rows along the cutting edge 28.

As can be seen in particular in FIG. 3, the cutting edge 28 is separated from the surface structures 34 by a strip-shaped transition portion 36 extending parallel to the cutting edge 28. Thus, the transition portion 36 subsequent to the cutting edge 28 is free of the surface structures 34, and only at the edge located away from the cutting edge 28 do the surface structures 34 begin on the chip face 26.

The width of the transition portion 36 is smaller than the width of the first row of surface structures 34, but it is at least 0.1 mm downstream of the protective chamfer adjacent the cutting edge 28.

Each of the surface structures 34 ends on its side facing away from the cutting edge 28 in a ledge 38 adjoining the next row of surface structures 34. The ledges 38 each have an end face 40, which has an inclination obliquely towards the underside 18 of the cutting insert 16 compared to the top side of the respective surface structure 34. Preferably, the inclination is greater than 90° and a maximum of 120° towards the top side 20 of the surface structures, i.e., the ledge 38 does not form an undercut towards the top side 20.

The surface structures 34 follow the general path of the chip face 26 which, as already discussed above, is inclined towards the underside 18 starting from the cutting edge 28. The chip face 26 is thereby preferably inclined at an angle of between 5° and 25°. Accordingly, the surface structures 34 also have an inclination angle of between 5° and 25°. This inclination angle relates to a base plane B (see FIG. 5), in which the cutting edge 28 is located, which may also have non-linear portions in plan view as shown by the corners of the cutting edge.

The base plane B is consequently a plane that has been figuratively placed on the cutting insert 16 from above and thus circumferentially contacts the cutting edge 28 comprising substantially rectangular but rounded corners.

The transition portion 36 forms a level part of the chip face 26 and defines a plane E (see FIG. 5) opposite to which the top side of the surface structures 34 occupy an angle a of 1°-8° so that the distance of the surface increases continuously from the plane E towards the ledges 38.

Plane E runs at an angle of 5°-20° to the aforementioned base plane B. Alternatively, and not shown in the figures, plane E may also be identical to the base plane B or have a negative angle of up to 25°, for example in the case of heavy machining.

In the figures, it can be seen that the surface structures 34 end convexly in plan view of the top side 20 of the cutting insert 16, i.e., the ledges 38 extend convexly. In particular, the edges of the surface structures 34, i.e., the ledges 38, are designed here as semicircles and circular segments or arcs. Alternatively, and not shown in the figures, the surface structures 34 may also end in a point or ellipsis, while the general shape still remains convex.

In FIG. 4, in particular, the dimensions of the surface structures 34 can be seen, with four rows A to D being present as compared to FIG. 3. Each surface structure 34 has a maximum length L measured in parallel to the cutting edge 28. The length L of the surface structures 34 is each between 0.06 and 0.2 mm, with the preferred length of each surface structure 34 being between 0.04 and 0.2 mm.

The surface structures 34 according to FIGS. 3 and 4 also each have a maximum width B, which is measured perpendicular to the length and thus to the cutting edge 28. The maximum width B is between 0.04 to a maximum 0.2 mm, preferably between 0.05 mm and 0.15 mm.

Accordingly, the length L of each surface structure 34 is greater than the maximum width B.

Generally, this results in a surface of the surface structures 34 of 0.02 to 2 mm² in plan view. Thus, the surface structures 34 are macrostructures.

However, depending on the exact dimensions of the surface structures 34, they may also be microstructures of less than 0.1mm².

Referring to FIGS. 3 and 4, it can be seen that the surface structures 34 of adjacent rows A, B, C, D optically overlap with each other with the surface size of the surface structures 34 of the row(s) lying closer to or decreasing to the lowest location of the chip-breaking trough 30.

The row A of surface structures 34 closest to the cutting edge 28 thus has surface structures 34 with the greatest surface. The size of the surface of the surface structures 34 increases from the lowest point in the chip-breaking trough 30 towards the cutting edge 28, in particular by a factor between 2 and 4, i.e., of row C (FIG. 3) and row D (FIG. 4) to row A.

The ledge 38 defining each surface structure 34 is preferably convex so that ledges 38 of the surface structures 34 together in a row form a type of wave pattern.

Adjacent surface structures 34 in a row merge into each other at least in the row A closest to the cutting edge 28. In the embodiment of FIG. 4, the surface structures 34 of all rows A to D merge into one another. Each of the surface structures 34, when viewed in plan view, ends at a recess 42 such that the ends of the convexly extending ledges 38 of adjacent surface structures 34 coincide at the lowest point of the recess 42. Thus, the transitions between adjacent ledges 38 within a row are comparatively pointed or have no transition roundings.

The surface structures 34 are arranged longitudinally to, i.e., along the cutting edge 28, parallel to, and offset from one another to adjacent rows A-D.

As can be seen in particular in FIG. 4, the surface structures 34 of adjacent rows A-D are offset from one another such that the most distant location of the surface structure 34 (location with the largest width) from the cutting edge 28 lies at a height of the recess 42 of the adjacent row positioned closer to the cutting edge 28. This results in a type of fish scale or roof tile pattern.

In rows B-D of the surface structures 34 that do not abut the transition portion 36 between the cutting edge 28, the individual surface structures 34 are not necessarily interconnected but may also be spaced apart from one another, as can be seen in FIG. 3 for the rows B and C.

It is shown in FIGS. 3 and 4 that the ledges 38 of the surface structures 34 may always have the same curvature, which represents an option.

In the embodiments of the cutting insert 16 shown in the figures, the top side of the surface structures 34 are level and configured free from undercuts also in the area of the ledges 38. Alternatively, however, the surface structures 34 may each have a curved top side such that the top side of the surface structures 34 has a curvature with a height between 0.02 mm and 0.2 mm.

Also not seen in the figures, the cutting insert 16 may contain friction-reducing particles that have lubricating properties or become softer through heating from the cutting chips and form a lubrication layer. By these friction-reducing particles, the friction-reducing effect of the surface structures 34 is further enhanced so that the service life of the cutting insert 16 can be extended. For example, the friction-reducing particles may be carbon (C), sulfur (S), or oil deposits in cavities provided for this purpose.

In FIG. 6, a possible method for producing the cutting insert 16 is shown. In a first step S 1, a sintered preform is provided or produced.

The sintered preform is positioned between two tool parts so that it can be compressed by the two tool parts. The tool parts are shaped complementary to the underside 18 and the top side 20. This represents step S 2. Since the top side 20 and the underside 18 do not have any undercuts, the surface can only be produced by a press motion in the axial direction of the hole 24.

In the last step S 3, the sintered preform is heated and sintered so that the cutting insert 16 can be subsequently removed from the two tool parts and installed in a cutting tool 10.

In this manufacturing method, a need for machining of the surface structures 34 is no longer necessary, and the cutting insert 16 may be installed directly after the manufacturing process. Alternatively, the cutting insert 16 may also be produced by laser structuring, rapid prototyping, or milling, in which case either the sintered preform or the sintered cutting insert is machined.

1. A cutting insert for a cutting tool having an underside, an oppositely directed top side, which has a chip face, a free surface adjacent to the chip face and a cutting edge defined at the transition between the chip face and the free surface, wherein the chip face extends away from the cutting edge and obliquely towards the underside, wherein the chip face has a plurality of surface structures, arranged in multiple rows longitudinally to and spaced apart from the cutting edge, wherein the surface structures end in a ledge from the row closer to the cutting edge and the adjacent row further from the cutting edge begins after the ledge, wherein the top side of the surface structures extend away from the cutting edge and obliquely towards the underside, wherein the ledges are convex in plan view of the top side.

2. The cutting insert according to claim 1, characterized in that the surface structures are macrostructures having a surface measuring from 0.02 to 2 mm² in plan view.

3. The cutting insert according to claim 1, characterized in that each surface structure has a length measured parallel to the closest area of the cutting edge that ranges from 0.06 to 0.2 mm and/or a width measured perpendicular to the closest area of the cutting edge that ranges from 0.04 to 0.2 mm, and each surface structure has a greater maximum length than a maximum width.

4. The cutting insert according to claim 1, characterized in that the ledges facing away from the cutting edge have an end face with an inclination greater than 90° and a maximum of 120° towards the top side of the respective surface structure from which it extends.

5. The cutting insert according to claim 1, characterized in that the cutting edge has non-linear portions when viewed in the plan view of the top side and the top side of all surface structures, relative to a base plane in which the cutting edge lies, is inclined at an angle of between 5 and 20°.

6. The cutting insert according to claim 1, characterized in that the adjacent surface structures merge at least in the closest row to the cutting edge and each surface structure is bound and defined in its longitudinal direction parallel to the closest area of the cutting edge by a singular, convexly extending ledge.

7. A cutting insert according to claim 1, characterized in that the adjacent surface structures at least the row closest to the cutting edge when viewed in plan view ends at a recess defined by the common end of the adjacent convexly extending ledges.

8. The cutting insert according to claim 7, characterized in that the surface structures of the adjacent row that is further away from the cutting edge than the adjacent row are offset from the surface structures of that adjacent row that extends parallel to the closest area of the cutting edge.

9. The cutting insert according to claim 8, characterized in that the top side of the surface structures of the adjacent row, which is further away from the cutting edge than the adjacent row, when viewed in plan view, has its greatest width at the imaginary straight line, measured perpendicular to the closest area of the cutting edge, where a recess of the adjacent row closer to the cutting edge is provided.

10. The cutting insert according to claim 1, characterized in that the surface of the top side of the surface structures of the rows closer to the cutting edge increases so that the surface of the top side of the surface structures decreases with increasing distance from the cutting edge.

11. The cutting insert according to claim 1, characterized in that the surface structures of the rows not closest to the cutting edge in the longitudinal direction, which is parallel to the closest area of the cutting edge, are spaced apart from each other.

12. The cutting insert according to claim 1, characterized in that, starting from the cutting edge, the top side comprises a chip-breaking trough and the surface structures are only present on the side of the trough close to the cutting edge.

13. The cutting insert according to claim 1, characterized in that a strip-shaped transition portion extending parallel to the cutting edge is provided starting from the cutting edge, which is free from the surface structures and at which edge located away from the cutting edge begins a first row of the surface structures.

14. The cutting insert according to claim 13, characterized in that the transition portion defines a level part of the chip face and between the plane defined by the transition portion and the top side of the surface structures there is an angle of 1°-8° such that the top side towards the ledges are increasingly spaced apart from the plane.

15. The cutting insert according to claim 1, characterized in that the top side of each surface structure is flat or domed upward.

16. The cutting insert according to claim 1, characterized in that the top side is formed without an undercut.

17. The cutting insert according to claim 1, characterized in that the cutting insert is a cutting plate, with cutting edge portions that run substantially linearly and merge into corners of the cutting plate.

18. The cutting insert according to claim 1, characterized in that the cutting insert contains friction-reducing particles that have lubricating properties or become softer through heating from the cutting chips and form a lubrication layer.

19. A cutting tool comprising a holder and a cutting insert according to claim 1, wherein the cutting insert is fixed to an end of the holder.

20. A method for producing a cutting insert according to claim 1, characterized by the steps of:
a sintered preform is produced,
the sintered preform is compressed between at least two tool parts shaped complementary to the top side and the underside, and
the sintered preform is heated and sintered.
